(19) United States
(12) Patent Application Publication
(10) Pub. No.: US 2011/0064943 A1
(43) Pub. Date: Mar. 17, 2011

(54) CONDUCTIVE SLICE STRUCTURE

(75) Inventor: HSIANG-HUA WANG, Miao-Li County (TW)

(73) Assignee: CHIMEI INNOLUX CORPORATION, Miao-Li County (TW)

(21) Appl. No.: 12/839,346

(22) Filed: Jul. 19, 2010

(30) Foreign Application Priority Data
Sep. 14, 2009 (CN) 200910306989.8

(51) Int. Cl. B32B 9/00

(52) U.S. Cl. 428/332; 428/688

(57) ABSTRACT

A conductive slice structure includes a substrate, a carbon nanotube (CNT) layer, and a first function layer. The conductive slice structure may further include a second function layer and a third function layer. The first function layer, the second function layer, and the third function layer each of which can be a refraction layer, an anti-smudge layer, an anti-fingerprint layer, an anti-glare layer, an anti-Newton rings layer, an anti-static layer, or an anti-scratch layer.

### BACKGROUND OF THE DISCLOSURE

1. Field of the Disclosure

The present disclosure relates to a conductive slice structure, and more particularly to a conductive slice structure with a carbon nanotube layer.

2. Description of Related Art

Touch panels or touch screens are widely applied in electronic apparatuses, particularly in portable or hand-held electronic apparatuses, such as personal digital assistants (PDA) or mobile phones. Touch panels include resistive-types, capacitive-types, and/or the inclusion optical touch technologies.

Typical touch panels include conductive layers of indium tin oxide (ITO), also known as ITO touch panels. Touch panels include conductive layers of carbon nanotubes (CNT) or CNT touch panels are recently proposed. FIG. 1 shows a cross-sectional view of a typical resistive-type CNT touch panel. The CNT touch panel includes an upper conductive slice structure including an upper substrate 10A and an upper CNT layer 11A, and a lower conductive slice structure including a lower substrate 10B and a lower CNT layer 11B. The upper and lower conductive slice structures are separated by spacers 12 and are bonded by sealant 13. A liquid crystal display panel 14 and a backlight module 15 providing light source are beneath the lower substrate 10B. During operation, the upper CNT layer 11A and the lower CNT layer 11B may contact each other, and the voltage value of a touch point may be changed when a finger or a stylus touches a touch point on the surface of the upper substrate10A. The coordinate of the touch point is determined through detecting the positions of voltage variation respectively.

FIG. 2 shows an enlarged cross-sectional view of upper or lower conductive slice structures. A conductive slice structure of a conventional CNT touch panel includes a substrate10 and a CNT layer 11. The CNT layer 11 is attached on the surface of the substrate10 through an adhesive (not shown).

Since the CNT layer 11 is constituted by carbon nanotubes which have optical, physical, chemical or electrical characteristics different to the ITO conductive layer, the optical, physical, chemical or electrical characteristics of the conventional conductive slice structure shown in FIG. 2 can be improved.

### SUMMARY OF THE DISCLOSURE

According to the embodiments of the present disclosure, the conductive slice structure has a substrate, a carbon nanotube layer, and a function layer above or beneath the carbon nanotube layer. The function layer has at least one of the functions including anti-reflection, anti-smudge, anti-fingerprint, anti-glare, anti-Newton rings, anti-static, and anti-scratch. Thus the optical, physical, chemical or electrical characteristics of the conductive slice structure and the performance of display apparatuses with CNT touch panels or CNT conductive layers can be improved.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 shows a cross-sectional view of a typical resistive-type CNT touch panel.

FIG. 2 shows an enlarged cross-sectional view of upper or lower conductive slice structures.

FIGS. 3, 4 and 5 show various conductive slice structures of the first embodiment of the present disclosure.

FIGS. 6, 7 and 8 show various conductive slice structures of the second embodiment of the present disclosure.

FIGS. 9 and 10 show various conductive slice structures of the third embodiment of the present disclosure.

### DESCRIPTION OF EMBODIMENTS

The detailed description of the present disclosure will be discussed in the following embodiments, which are not intended to limit the scope of the present disclosure, but can be adapted for other applications. While drawings are illustrated in details, it is appreciated that the scale of each component may not be expressly exactly.

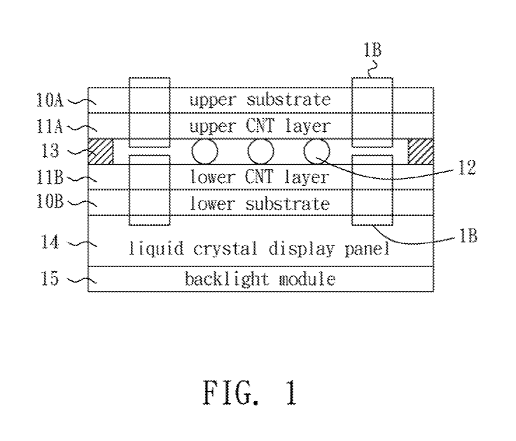

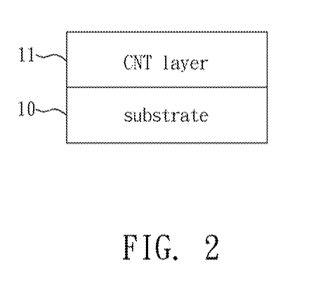

In the following discussed embodiments, the disclosed conductive slice structures can be applied in the CNT touch panel shown in FIG. 1. However, the disclosed conductive slice structures can also be applied in CNT touch panels or display apparatuses with a CNT conductive layer other than that shown in FIG. 1.

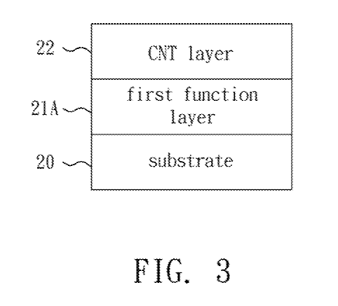

FIG. 3 shows a conductive slice structure of a first embodiment of the present disclosure. In this embodiment, the conductive slice structure includes a substrate 20, a CNT layer 22, and a first function layer 21A between the substrate 20 and the CNT layer 22. The substrate 20 includes a transparent insulating layer, and the transparent insulating layer is selected from one of the following materials or is a combination of portions of the following materials: Poly-Ethylene-Terephthalate (PET), Polycarbonate (PC), Poly-Methyl-Meth-Acrylate (PMMA), Polyvinylchloride (PVC), Triacetyl cellulose (TAC, and glass. The CNT layer 22 can be a carbon nanotube film, where the carbon nanotube film includes a conductive film conformation with porous and silk, grating or net structures manufactured by extending single-wall or multi-wall carbon nanotube single-axially or multi-axially. The carbon nanotube film has minimum electric impedance along the extending direction and maximum electric impedance perpendicular to the extending direction so as to form anisotropic impedance.

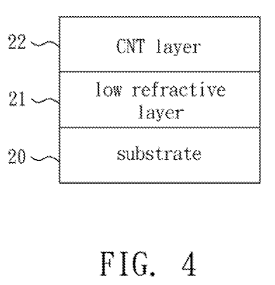

In this embodiment, the first function layer 21A includes a layer or a plurality of layers formed by coating or thin film technologies. In one embodiment, the first function layer 21A can be a low refractive layer 21 (LR layer). The refractive index of the low refractive layer 21 is constant and less than the refractive index of the substrate 20, and is used as an anti-reflection layer (AR layer) to improve transparency or transmission coefficient. As shown in FIG. 4, in this embodiment, the refractive index of the low refractive layer 21 is less than about 1.49 and greater than about 1.2. The material of low refractive layer 21 includes organic or inorganic materials with fluorine or silicon. In this embodiment, the thickness of the low refractive layer 21 is in the range of about 0.05 to about 10 um. Since the CNT layer 22 is a porous conductive film, the refractive indexes of the CNT layer 22 and the substrate 20 do not match such that the light is easily reflected. The low refractive layer 21 of this embodiment decreases the reflected light.

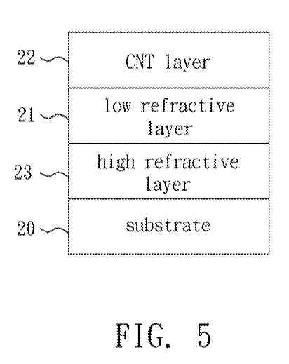

In another embodiment, the first function layer 21A includes the low refractive layer 21 mentioned above and a high refractive layer 23. The refractive index of the high refractive layer 23 is constant, greater than the refractive index of the low refractive layer 21 and less than the refractive index of the substrate 20. In one embodiment, the refractive index of the high refractive layer 23 is greater than about 1.55. The material of the high refractive layer 23 can be polymer materials with a high refractive index or inorganic materials with a high refractive index such as TiO2, ITO and aluminum implanted zinc oxide (AZO), etc. The combination of the high refractive layer 23 and the low refractive layer 21 forms an anti-reflection layer to prevent or decrease the light leakage loss resulting from reflection to improve transparency as shown in FIG. 5.

The first function layer 21A can be an anti-smudge layer to prevent or decrease contaminants through the spaces between carbon nanotubes of the CNT layer 22 into the conductive slice structure. An anti-fingerprint layer similar to the anti-smudge layer is utilized to prevent or decrease pollutions of grease or water of fingerprint on the conductive slice structure. The materials of the anti-smudge or anti-fingerprint first function layer 21A can be polymer materials with hydrophobic functional groups such as polymer materials with fluorine or silicon.

The first function layer 21A can be an anti-glare layer or an anti-Newton rings layer to prevent or decrease glare and the decrease of contrast ratio resulting from scattering of light or high intensity light. The materials of anti-glare or anti-Newton rings layers of the first function layer 21A can be layers with organic or inorganic particles (1-5 um) or layers with surface having micro structures formed by physical imprinting or chemical formation processes.

The first function layer 21A can also be an anti-static layer. The materials of the anti-static layer include anti-static particles and resin or resin with low dielectric constant.

The first function layer 21A can also be an anti-scratch layer or a high hardness layer to prevent or decrease the damages of the conductive slice structure caused by frequently contacts or collisions. The anti-scratch first function layer 21A includes organic polymer harden layers with functional groups such as Poly-Methyl-Meth-Acrylate (PMMA), epoxy, Polyurethane etc., or inorganic silicon dioxide harden layers.

According to the first embodiment shown in FIG. 3, the first function layer 21A is selected from one or more above-mentioned function layers, such as the anti-reflection layer, the anti-smudge layer, the anti-fingerprint layer, the anti-glare layer, the anti-Newton rings layer, the anti-static layer, and the anti-scratch layer. Thus the optical, physical, chemical or electrical characteristics of the conductive slice structure and the performance of display apparatuses with CNT touch panels or CNT conductive layers can be improved. The adhesion between the multiple layers of the first function layer 21A, or the adhesion between the first function layer 21A, the substrate 20, and the CNT layer 22 are achieved through the adhesive of the first function layer 21A or an additional adhesive.

In another embodiment, the first function layer 21A is disposed on and contacts the CNT layer 22, which means that the CNT layer 22 is between the first function layer 21A and the substrate 20. The thickness of the first function layer 21A is limited to ensure that voltage values on the CNT layer 22 can be changed when the CNT layer 22 is pressed. The thickness of the first function layer 21A is preferably in the range of about 2 um to about 0.05 um.

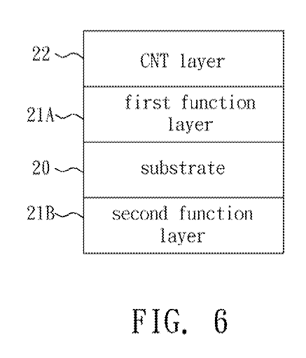

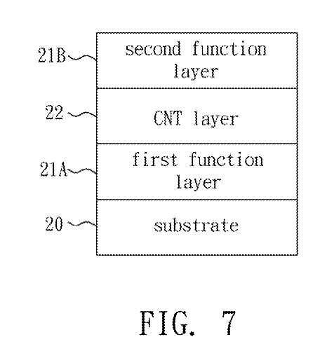

FIG. 6 shows a conductive slice structure of a second embodiment of the present disclosure. In this embodiment, the conductive slice structure includes a substrate 20, a CNT layer 22, a first function layer 21A between the substrate 20 and the CNT layer 22, and a second function layer 21B disposed on a side of the substrate 20 against the first function layer 21A. The second function layer 21B can also be on a side of the CNT layer 22 against the substrate 20 as shown in FIG. 7. The CNT layer 22, the first function layer 21A, and the substrate 20 shown in FIGS. 3A and 3B are similar to those in the first embodiment, and thus the functions and materials of the CNT layer 22, the first function layer 21A, and the substrate 20 are not particularly described again. The difference between the first and second embodiments is the second function layer 21B. The second function layer 21B includes a layer or a plurality of layers formed by coating or thin film technologies. The second function layer 21B is selected from one or more above-mentioned function layers, such as the anti-reflection layer, the anti-smudge layer, the anti-fingerprint layer, the anti-glare layer, the anti-Newton rings layer, the anti-static layer, and the anti-scratch layer.

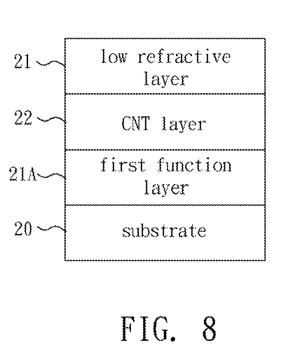

In one embodiment, the second function layer 21B can be a low refractive layer 21 to improve transparency or transmission coefficient as shown in FIG. 8. In this embodiment, the thickness of the low refractive layer 21 is in the range of about 0.05 to about 2 um. Since the second function layer 21B in FIG. 7 or the low refractive layer 21 in FIG. 8 applied in CNT touch panels needs to face another CNT layer of another conductive slice structure, the thickness of the second function layer 21B or the low refractive layer 21 is limited to less than a thickness such as less than about 2 um to ensure that the conductivity between the CNT layers 22 of the conductive slice structures, and voltage values on the CNT layer 22 can be changed when the CNT layer 22 is pressed.

According to the second embodiment shown in FIG. 6, the first function layer 21A and the second function layer 21B are respectively selected from one or more above-mentioned function layers, such as the anti-reflection layer, the anti-smudge layer, the anti-fingerprint layer, the anti-glare layer, the anti-Newton rings layer, the anti-static layer, and the anti-scratch layer. Thus the optical, physical, chemical or electrical characteristics of the conductive slice structure and the performance of display apparatuses with CNT touch panels or CNT conductive layers can be improved.

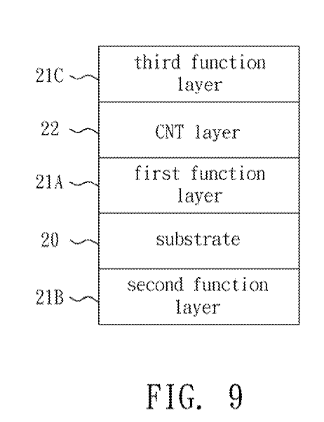

FIG. 9 shows a conductive slice structure of a third embodiment of the present disclosure. In this embodiment, the conductive slice structure includes a substrate 20, a CNT layer 22, a first function layer 21A between the substrate 20 and the CNT layer 22, a second function layer 21B disposed on the side of the substrate 20 against the CNT layer 22, and a third function layer 21C on the side of the CNT layer 22 against the substrate 20. The CNT layer 22, the first function layer 21A, the substrate 20, and the second function layer 21B are similar to those in the second embodiment, and thus the functions and materials of the CNT layer 22, the first function layer 21A, the substrate 20, and the second function layer 21B are not particularly described again. The difference between the second and third embodiments is the third function layer 21C. The third function layer 21C includes a layer or a plurality of layers formed by coating or thin film technologies. The third function layer 21C is selected from one or more above-mentioned function layers, such as the anti-reflection layer, the anti-smudge layer, the anti-fingerprint layer, the anti-glare layer, the anti-Newton rings layer, the anti-static layer, and the anti-scratch layer. Since the first function layer 21A is between other layers in this embodiment, functions of anti-smudge, anti-fingerprinting and anti-scratch are less necessary.

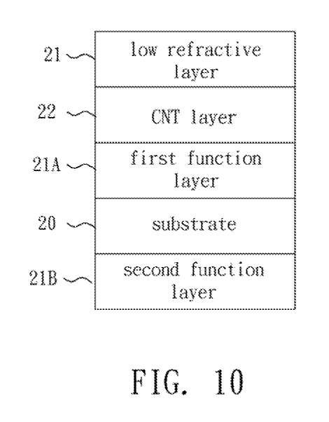

In one embodiment, the third function layer 21C can be a low refractive layer 21 to improve transparency or transmission coefficient as shown in FIG. 10. In this embodiment, the thickness of the low refractive layer 21 is in the range of about 0.05 to about 2 um. Since the third function layer 21C in FIG. 9 or the low refractive layer 21 in FIG. 10 faces another CNT layer of another conductive slice structure, the thickness of the third function layer 21C or the low refractive layer 21 is limited to less than a thickness such as less than about 2 um to ensure that the conductivity between the CNT layers 22 of the conductive slice structures.

According to the third embodiment shown in FIG. 9, the first function layer 21A, the second function layer 21B, and the third function layer 21C are respectively selected from one or more above-mentioned function layers, such as the anti-reflection layer, the anti-smudge layer, the anti-fingerprint layer, the anti-glare layer, the anti-Newton rings layer, the anti-static layer, and the anti-scratch layer. Thus the optical, physical, chemical or electrical characteristics of the conductive slice structure and the performance of display apparatuses with CNT touch panels or CNT conductive layers can be improved.

Although specific embodiments have been illustrated and described, it will be appreciated by those skilled in the art that various modifications may be made without departing from the scope of the present disclosure, which is intended to be limited solely by the appended claims.

What is claimed is:

1. A conductive slice structure, comprising:
a substrate;
a carbon nanotube layer; and
a first function layer having at least one of functions including anti-reflection, anti-smudge, anti-fingerprint, anti-glare, anti-Newton rings, anti-static, and anti-scratch.

2. The conductive slice structure according to claim 1, wherein the first function layer and the carbon nanotube layer are on one side of the substrate, and the first function layer comprises at least one of an anti-reflection layer, an anti-glare layer, an anti-Newton rings layer, and an anti-scratch layer.

3. The conductive slice structure according to claim 2, wherein the anti-reflection layer comprises a low refractive layer, the refractive index of the low refractive layer is constant and is less than the refractive index of the substrate.

4. The conductive slice structure according to claim 3, wherein the refractive index of the low refractive layer is less than about 1.49.

5. The conductive slice structure according to claim 4, wherein the refractive index of the low refractive layer is greater than about 1.2.

6. The conductive slice structure according to claim 3, wherein the anti-reflection layer further comprises a high refractive layer, the refractive index of the high refractive layer is constant and is greater than the refractive index of the low refractive layer, and is smaller the refractive index of the substrate.

7. The conductive slice structure according to claim 3, wherein the low refractive layer is between the carbon nanotube layer and the substrate, and the thickness of the low refractive layer is less than about 10 um.

8. The conductive slice structure according to claim 2, wherein the carbon nanotube layer is between the first function layer and the substrate, the first function layer contacts the carbon nanotube layer, and the thickness of the first function layer is less than about 2 um.

9. The conductive slice structure according to claim 2 further comprising a second function layer on another side of the substrate having at least one of functions including anti-reflection, anti-smudge, anti-fingerprint, anti-glare, anti-Newton rings, anti-static, and anti-scratch.

10. A conductive slice structure, comprising:
a substrate;
a carbon nanotube layer; and
a first function layer, wherein the carbon nanotube layer is between the first function layer and the substrate, the first function layer contacts the carbon nanotube layer, and the thickness of the first function layer is less than about 2 um.

11. The conductive slice structure according to claim 10, wherein the first function layer comprises at least one of an anti-reflection layer, an anti-glare layer, an anti-Newton rings layer, and an anti-scratch layer.

12. The conductive slice structure according to claim 11, wherein the anti-reflection layer comprises a low refrative layer, the refractive index of the low refractive layer is constant and is less than the refractive index of the substrate.
